(19) United States
(12) Patent Application Publication
(10) Pub. No.: US 2005/0129864 A1
(43) Pub. Date: Jun. 16, 2005

(54) Fabric material processing method

(76) Inventor: Ming-Theng Wang, Chung Ho City (TW)

Correspondence Address: WANG, Ming-Theng, PO Box 82-144, Taipei, TW

(21) Appl. No.: 10/735,832

(22) Filed: Dec. 16, 2003

(51) Int. Cl. B05D 7/00; B05D 3/02

(52) U.S. Cl. 427/421.1; 427/209; 427/372.2; 427/331

(57) ABSTRACT

A fabric material processing method of processing a fabric material to make the top surface hydrophobic and the bottom surface hydrophilic by: coating the fabric material with a layer of nanostructured metal liquid and dipping the fabric material in a nanostructured water repellant solution after drying of the nanostructured metal liquid, and then spraying a solvent on the bottom side of the fabric material to remove water repellant from the bottom side of the fabric material, and then grinding the fabric material to remove nanostructured metal from thee bottom side of the fabric material, and then drying desizing the fabric material, and then washing the fabric material with clean water, and finally drying the fabric material again.

### BACKGROUND OF THE INVENTION

1. Field of the Invention

The present invention relates a fabric material processing method and, more specifically, to a method of processing a fabric material to have a hydrophobic top surface and a hydrophilic bottom surface.

2. Description of the Related Art

Because of the effect of material properties, regular fabric materials can breathe and absorb water when not specially treaded. For special purposes, fabric materials can be processed to have hydrophobic property. However, hydrophobic fabric materials do not breathe. It is not comfortable to wear clothes made of hydrophobic fabric materials.

Further, the so-called “lotus effect” mainly means the superhydrophobicity and self-cleaning features of lotus. When rainwater dropped to the hydrophobic surface of the leaves of a lotus, it forms into water beads due to the effect of surface tension, i.e., the contact angle between the surface of the leaves of the lotus and water will be over 140°, and the water beads will roll away from the leaves when shaking the leaves. Further, rolling water beads carry dust from the surface of the leaves. Therefore, the surface of the leaves is maintained clean and dry after a heavy rain.

Through an electronic microscope, we can see that the surface of a lotus leaf has protruding epidermal cells of size about 5˜15 μm, and a wax crystal of about one nanometer covered on each epidermal cell. The chemical structure of the wax crystal is hydrophobic. When water contacted the surface of a lotus leaf, it forms into water beads due to the effect of surface tension. Due to the effect of the fine protruding epidermal cell structure, the contact area between water and the surface of the leaf is minimized and the contact angle between water and the surface of the leaf is maximized, enhancing the effect of hydrophobicity, and lowering the adhesion power of solid matter to the surface of the leaf.

Actually, the nanometered fine structure acts an important role in self-cleaning. The contact area between water beads and the surface of a lotus leaf is about 2˜3% of the total area of the leaf. When tilting the leaf, rolling water beads immediately pick up solid matter from the surface of the leaf, achieving a cleaning effect. However, rolling water beads on the hydrophobic smooth surfaces of other plants or man-made products cannot cause water beads to carry solid matter from the surfaces.

In the natural world, plants are exposed to different pollutants including dust, mud, organic bacteria, fungi, and etc. In addition to the function of self-cleaning, the fine nanometered surface structure of lotus leaves prohibits infection of bacteria and virus. Lotus leaves become clean and fresh when washed by a heavy rain.

Therefore, it is desirable to provide a fabric processing method of processing fabric material to have a hydrophobic top surface and a hydrophilic bottom surface.

### SUMMARY OF THE INVENTION

The present invention has been accomplished under the circumstances in view. It is the main object of the present invention to provide a fabric processing method, which is practical to process fabric materials to have a top surface that provides hydrophobic, self-cleaning, dust-proof, and anti-bacteria features, and a bottom surface that breathes and absorbs water.

According to the first embodiment of the present invention, the fabric material processing method includes the steps of (a) coating the surface of each of the top and bottom sides of a prepared fabric material with a layer of nanostructured metal liquid; (b) drying the fabric material, (c) dipping the fabric material in a nanostructured water repellant solution to absorb water repellant, (d) drying the fabric material, (e) spraying a solvent on the surface of the bottom side of the fabric material to remove water repellant from the surface of the bottom side of the fabric material, (f) grinding the surface of the bottom side of the fabric material with a grinding wheel before drying of the solvent, so as to remove nanostructured metal from the surface of the bottom side of the fabric material, (g) drying the fabric material and then desizing the fabric material, (h) washing the fabric material with clean water, and (i) drying the fabric material.

According to the second embodiment of the present invention, a nanostructured metal and a nanostructured resin are mixed to form a nanostructured solution, which is then sprayed on the top surface of the prepared fabric material, and then the fabric material is dried, and then the nanostructured solution spraying and fabric material drying steps are repeated three times.

### BRIEF DESCRIPTION OF THE DRAWINGS

FIG. 1 is a series of schematic drawings showing the processing process of the first embodiment of the present invention.

FIG. 2 is a schematic drawing showing the processing process of the second embodiment of the present invention.

### DETAILED DESCRIPTION OF THE INVENTION

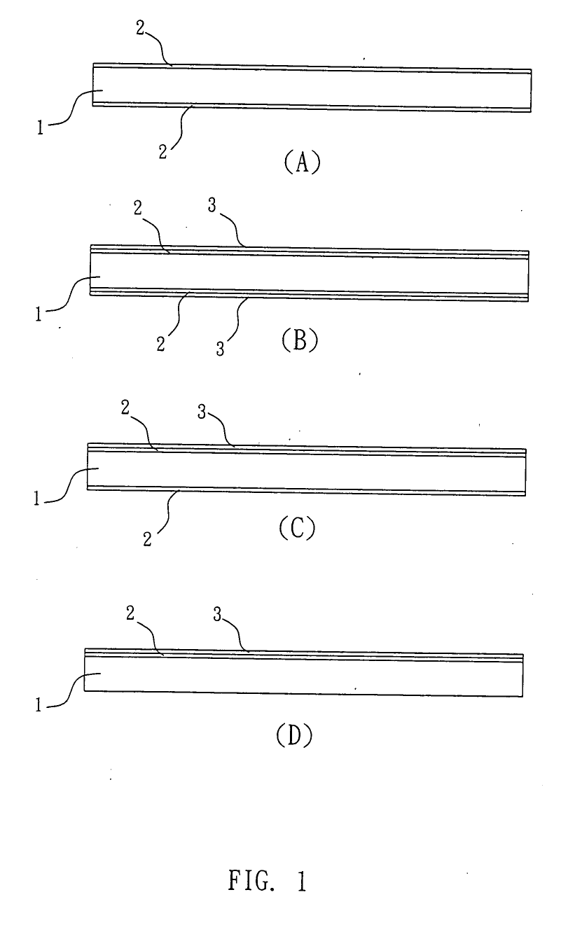

Referring to FIG. 1, a fabric material processing process in accordance with the first embodiment of the present invention comprises the steps of:
(a) Coating the surface of a prepared fabric material with a layer of nanostructured metal liquid;
(b) Drying the fabric material;
(c) Dipping the fabric material in a nanostructured water repellant solution to absorb water repellant;
(d) Drying the fabric material;
(e) Spraying a solvent on the bottom surface of the: fabric material to remove water repellant;
(f) Grinding the bottom surface of the fabric material with a grinding wheel before drying of the solve so as to remove nanostructured metal from the bottom surface of the fabric material;
(g) Drying the fabric material and then desizing the fabric material;
(h) Washing the fabric material;
(i) Drying the fabric material.

The aforesaid nanostructured metal liquid is a water solution containing 1% nanostructured titanium dioxide (TiO₂), silicon dioxide (SiO₂), or zinc dioxide (ZnO₂) of molecule diameter about 20 nanometers, and 10% water soluble dextrin or polyethylene. Deionized water, water wax, or any of a variety of other solutions that soluble in alcohol may be used to substitute for water for mixing with nanostructured titanium dioxide (TiO₂)/silicon dioxide (SiO₂)/zinc dioxide (ZnO₂) and water soluble dextrin or polyethylene. After coating of the prepared nanostructured metal liquid on the fabric material 1 and drying of the nanostructured metal liquid, nanostructured metal fills open spaces in the top and bottom surfaces of the fabric material 1, thereby causing an isolation layer 2 to be formed on each of the top and bottom surfaces of the fabric material 1 (see FIG. 1A).

The aforesaid nanostructured water repellant solution is a methylbenzene solution containing 1% nanostructured metal (for example, titanium dioxide, silicon dioxide, or zinc dioxide), 1% stearate, and 1.2% silicon water repellant. Iso-acetone may be used to substitute for methylbenzene. After the formation of the isolation layer, the fabric material is directly dipped in the nanostructured water repellant solution, enabling a layer of water repellant to be adhered to the surface of the isolation layer 2, and therefore a water repellant layer 3 is formed on the surface of the isolation layer 2 when dried (see FIG. 1B). Thereafter, a solvent is sprayed over the bottom side of the fabric material 1 to remove the water repellant layer 3 from the bottom side of the fabric material 1 (see FIG. 1C). Before drying of the fabric material 1, a grinding wheel is used to grind the bottom side of the fabric material 1 and to further remote the isolation layer 2 (the nanostructured metal layer) from the bottom side of the fabric material 1 (see FIG. 1D). Thereafter, the fabric material is baked to a dry status, and then desized, and then washed, and finally baked to a dry status. Thus the finished fabric material has a hydrophobic top surface that repel water, and a hydrophilic bottom surface that breathes and absorbs water.

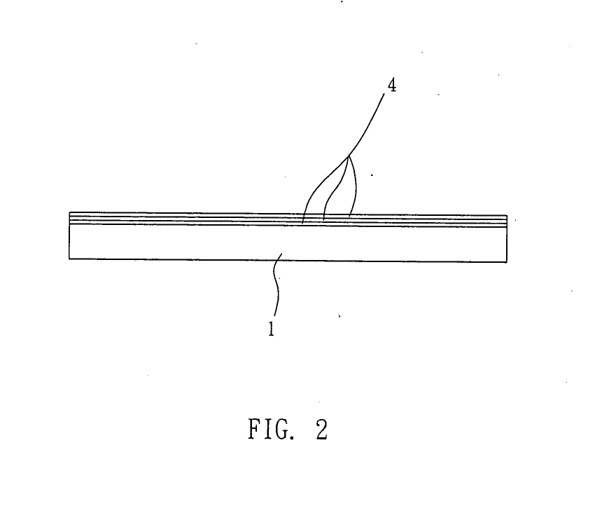

FIG. 2 is a schematic drawing showing the processing process of the second embodiment of the present invention. According to this embodiment, nanostructured metal and nanostructured resin are mixed to form a coating solution 4, and then the coating solution 4 is sprayed over the surface of the fabric material 1, and then the fabric material 1 is dried, and then the coating solution 4 spraying and fabric material drying steps are repeated three times, forming a water repellant layer on the top surface of the fabric material 1, which water repellant layer fills up open spaces in the top surface of the fabric material 1. When finished, the bottom side of the fabric material 1 is maintained hydrophilic.

According to the aforesaid second embodiment of the present invention, high polymer resin is mixed with a nanostructured metal oxide compound, and then the compound is sprayed over the top surface of the fabric material at room temperature. When the high polymer resin hardened, it serves as an interface to bind the nanostructured metal oxide compound to the top surface of the fabric material, enabling nanometered metal oxide particles to fill up open spaces in the top surface of the fabric material, and therefore the top surface of the fabric material has self-cleaning and hydrophobic properties like the leaves of a lotus.

Although particular embodiments of the invention have been described in detail for purposes of illustration, various modifications and enhancements may be made without departing from the spirit and scope of the invention. Accordingly, the invention is not to be limited except as by the appended claims.

1. A fabric material processing method comprising the steps of:
(a) Coating the surface of each of top and bottom sides of a prepared fabric material with a layer of nanostructured metal liquid;
(b) Drying said fabric material;
(c) Dipping said fabric material in a nanostructured water repellant solution to absorb water repellant;
(d) Drying said fabric material;
(e) Spraying a solvent on the surface of the bottom side of said fabric material to remove water repellant from the surface of the bottom side of said fabric material;
(f) Grinding the surface of the bottom side of said fabric material with a grinding wheel before drying of said solvent, so as to remove nanostructured metal from the surface of the bottom side of said fabric material;
(g) Drying said fabric material and then desizing said fabric material;
(h) Washing said fabric material with clean water; and
(i) Drying said fabric material.

2. The fabric material processing method as claimed in claim 1, wherein said nanostructured metal liquid is a water solution containing 1% nanostructured titanium dioxide (TiO₂), and 10% water soluble dextrin.

3. The fabric material processing method as claimed in claim 1, wherein said nanostructured metal liquid is a water solution containing 1% nanostructured silicon dioxide (SiO₂), and 10% water soluble dextrin.

4. The fabric material processing method as claimed in claim 1, wherein said nanostructured metal liquid is a water solution containing 1% nanostructured zinc dioxide (ZnO₂), and 10% water soluble dextrin.

5. The fabric material processing method as claimed in claim 1, wherein said nanostructured metal liquid is a water solution containing 1% nanostructured titanium dioxide (TiO₂), and 10% polyethylene.

6. The fabric material processing method as claimed in claim 1, wherein said nanostructured metal liquid is a water solution containing 1% nanostructured silicon dioxide (SiO₂), and 10% polyethylene.

7. The fabric material processing method as claimed in claim 1, wherein said nanostructured metal liquid is a water solution containing 1% nanostructured zinc dioxide (ZnO₂), and 10% polyethylene.

8. The fabric material processing method as claimed in claim 1, wherein said nanostructured water repellant solution is a methylbenzene solution containing 1% nanostructured metal, 1% stearate, and 1.2% silicon water repellant.

9. The fabric material processing method as claimed in claim 1, wherein said nanostructured water repellant solution is an iso-acetone solution containing 1% nanostructured metal, 1% stearate, and 1.2% silicon water repellant.

10. A fabric material processing method comprising the steps of (a) mixing a nanostructured metal with a nanostructured resin to form a nanostructured solution, (b) spraying said nanostructured solution on the top surface of a fabric material and then drying said fabric material, and (c) repeating step (a) and step (b) three times.
